(19) United States
(12) Patent Application Publication
(10) Pub. No.: US 2008/0041318 A1
(43) Pub. Date: Feb. 21, 2008

(54) Combination Pet Bed and Restraint Device

(76) Inventor: Mark McCabe, Westminster, CO (US)

Correspondence Address: QUICKPATENTS, INC., 32861 CALLE PERFECTO, SUITE A, SAN JUAN CAPISTRANO, CA, 92675, US

(21) Appl. No.: 11/840,473

(22) Filed: Aug. 17, 2007

Related U.S. Application Data
(60) Provisional application No. 60/838,736, filed on Aug. 18, 2006.

(51) Int. Cl. A01K 29/00; A01K 1/00

(52) U.S. Cl. 119/416; 119/28.5

(57) ABSTRACT

The present invention is a combination bed and restraint for a pet. The pet is contained in a soft flexible blanket type device that is closed over the animal in such a way that only the head is exposed. The restraint is secured by the use of an attachment means. The device has a built in bottom that prevents escape and allows for fast, easy, one step wrapping of the pet. When not in use, it serves as a bed for the pet which makes it a familiar object to the pet, thus facilitating the process of using the device as a restraint when necessary.

### CROSS-REFERENCE TO RELATED APPLICATIONS

This application claims the benefit of U.S. Provisional Patent Application 60/838,736, filed on Aug. 18, 2006.

### STATEMENT REGARDING FEDERALLY SPONSORED RESEARCH AND DEVELOPMENT

Not Applicable.

### FIELD OF THE INVENTION

This invention relates to pet beds and pet restraints, and more particularly to a combination pet bed and pet restraint device.

### DISCUSSION OF RELATED ART

The combination of pet beds with other devices is seen in the art. The combinations consist primarily of pet beds and pet carriers. U.S. Pat. No. 6,907,842 to Godshaw, published on Jun. 21, 2005 teaches a combination pet bed and carrying case. US Patent Application 2006/0070577 A1 to Foley, published on Apr. 6, 2006, teaches a combined pet cushion cover and tote. US Patent Application 2004/0050339 A1 to Johnson et al., published on Mar. 18, 2004, teaches a pet bed convertible to a pet carrier. However, the prior art does not teach the concept of combining a pet bed with a pet restrainer.

Pet restrainers by themselves are well known in the art. For example, US Patent Application 2006/0060155 A1 to Ip, published on Mar. 23, 2006 teaches an animal restraint for vets and pet owners and U.S. Pat. No. 5,230,304 to Santoro, published on Jul. 27, 1993, teaches an animal treatment and handling device. But these devices do not teach combining a pet restrainer with a pet bed, but instead teach away from the combination of a pet restrainer and pet bed. The Ip device teaches a tubular restraint and does not teach a flat bed like design. The Santoro device teaches a device designed to be used with liquids to apply medicine to a pet's body and teaches away from using a soft bedding material for the inner lining of the restrainer.

Restraining a pet can be difficult, especially restraining a pet such as a cat. Cats tend to be independent animals that do not prefer being restrained. The act of restraining a pet can be traumatic to the pet. Furthermore, cats have sharp teeth and claws that make restraining a pet potentially dangerous to the owner or vet. Therefore, a device is needed that makes the act of restraining less stressful for a pet. Furthermore, such a device would provide protection for the person doing the restraining.

To reduce the stress of restraining the pet and facilitate the process of restraining, the restrainer should be a device that is familiar and comfortable to a pet. US Patent Application 2004/0050339 A1 to Johnson et al., published on Mar. 18, 2004, teaches a pet bed convertible to a pet carrier for the benefit of reducing the pet's stress of being transported by using a device familiar to the pet. However, the Johnson device does not teach combining a pet bed with a pet restrainer, nor how to combine a pet bed with a pet restrainer. Therefore, there is a need for a pet restrainer that facilitates the restraining of a pet by also serving as the pet's bed to familiarize the pet with the device and thereby reducing the pet's resistance to being restrained.

Moreover, in order to effectively serve as both a restrainer and a bed, the device needs to be suitable for both functions. As a pet bed, the device would need to open up to a size suitable for a pet bed and be made of a material that is attractively comfortable to a pet. As a restrainer, a device would allow for fast, easy, one step wrapping of the pet before the pet can resist being restrained. The needed device would further have a built in bottom to prevent the pet from easily escaping or sliding out from the restrainer. Also, the device would provide a suitable layer of material to protect the person doing the restraining.

In addition to all the needs described above of being a pet bed and a restrainer, such a needed device would need to be easily convertible between being a pet restrainer and a pet bed. Therefore a device is needed that can function as a pet bed yet be designed to easily convert to a pet restrainer. Furthermore, as the device would be used with animals, the device would need to be durable and easily washable. Finally, as owning pets is enjoyed by people of all income levels, such a needed device should be as economical in design as possible to be affordable to all pet owners.

Therefore, there is a need for a pet restrainer that facilitates the restraining of a pet by serving as a pet bed to familiarize the pet with the device. The device would have an easy to use economical design but remain highly effective as a restrainer and bed. As the device would be used with animals, the device would be durable and easily washable. The present invention accomplishes these objectives.

### SUMMARY OF THE INVENTION

The present invention is a combination bed and restraint for a pet. The combination includes a flexible sheet having a top surface, a bottom surface, and at least one peripheral edge. The flexible sheet includes a two-part fastening means on the bottom and top surfaces. The top surface of the flexible sheet functions as the bed. The combination further includes an end sheet having an inside surface, and outside surface, and at least one peripheral edge. The peripheral edge of the end sheet is fixed to at least a portion of the peripheral edge of the flexible sheet, such as by a sewn stitch, and each sheet may be hemmed along its edge, respectively.

A distal end of the flexible sheet terminates at the end sheet and a proximal end of the flexible sheet may be either laid substantially flat, thereby forming the bed, or wrapped around the pet and fastened to itself with the fastening means, thereby forming the restraint. Preferably, the pet is contained in the restraint in such a way that the pet's head is the only part of the pet exposed.

In one embodiment, the top surface of the flexible sheet further includes a soft, cushioning material. Providing a soft cushioning material makes the invention suitable as a bed. The flexible sheet is comprised of a soft flexible inner layer and a durable, flexible outer layer, each layer mutually fixed together. The soft flexible inner layer provides a soft surface for a pet to rest on and the durable flexible outer layer provides protection for a person restraining the pet.

In a preferred embodiment, the inner layer is taken from the set of materials comprising: fleece, wool, leather, and sheepskin. In another preferred embodiment, the outer layer is taken from the set of materials comprising: fleece, leather, cotton, nylon, polyester, and denim. The invention has a novel design of being economical as it is made of basic materials and simple construction, yet is highly effective because the end sheet prevents the pet from escaping or slipping out of the restraint. Furthermore, the invention can be made of materials that are durable and washable.

The inner layer further includes at least one aperture sealable with a fastening means, and further including a resilient stiffener insertable into the aperture between the inner and outer layers to form a resilient bed wall around a back periphery of the combination when used as a bed. The resilient bed wall provides a enclosure which is attractive to pets, especially cats, when they are selecting a place to rest. Preferably, the resilient stiffener is easily removable from the aperture to facilitate the washing of the invention. In another preferred embodiment, the end sheet includes an end stiffener. The end stiffener provides structural support to the end sheet to facilitate the restraining of a pet.

The invention is specifically designed to be attractive as a bed for a pet. The invention opens up to a size suitable for a pet bed and is made of a material that is attractively comfortable to a pet but is still effective as a restraint. When not in use as a restraint, the combination serves as a bed for the pet which makes the invention a familiar object to the pet. The familiarity of the pet with the invention reduces the pet's resistance to being restrained and the pet's stress, thereby facilitating restraint of the pet.

The present device is a pet restrainer that facilitates the restraining of a pet by serving as a pet bed to familiarize the pet with the device. The device would have an easy to use economical design but remain highly effective as a restrainer and bed. As the device would be used with animals, the device would be durable and easily washable. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of the invention, illustrating a person restraining a pet;

FIG. 2 is a perspective view of the invention, illustrating the open state of the invention as a bed;

FIG. 3 is a perspective view of the invention, illustrating the closed state of the invention as a restraint;

FIG. 4 is a cross-sectional view of the invention, taken generally along lines 4-4 of FIG. 3;

FIG. 5 is a perspective view of the invention, illustrating a resilient stiffener and the open state of the invention as a bed;

FIG. 6 is a perspective view of the invention, illustrating an inserted resilient stiffener into the invention;

FIG. 7 is a cross-sectional view of the invention, taken generally along lines 7-7 of FIG. 6, illustrating an inserted resilient stiffener; and

FIG. 8 is a cross-sectional view of the invention, taken generally along lines 4-4 of FIG. 3, illustrating an end stiffener.

### DETAILED DESCRIPTION OF THE PREFERRED EMBODIMENT

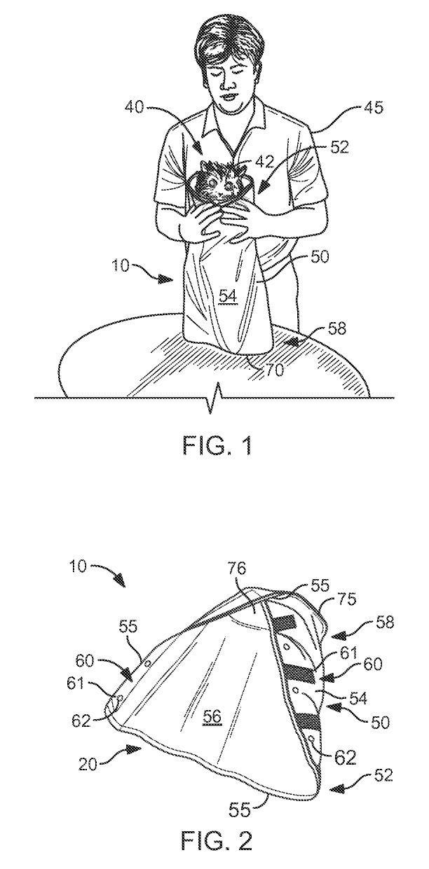

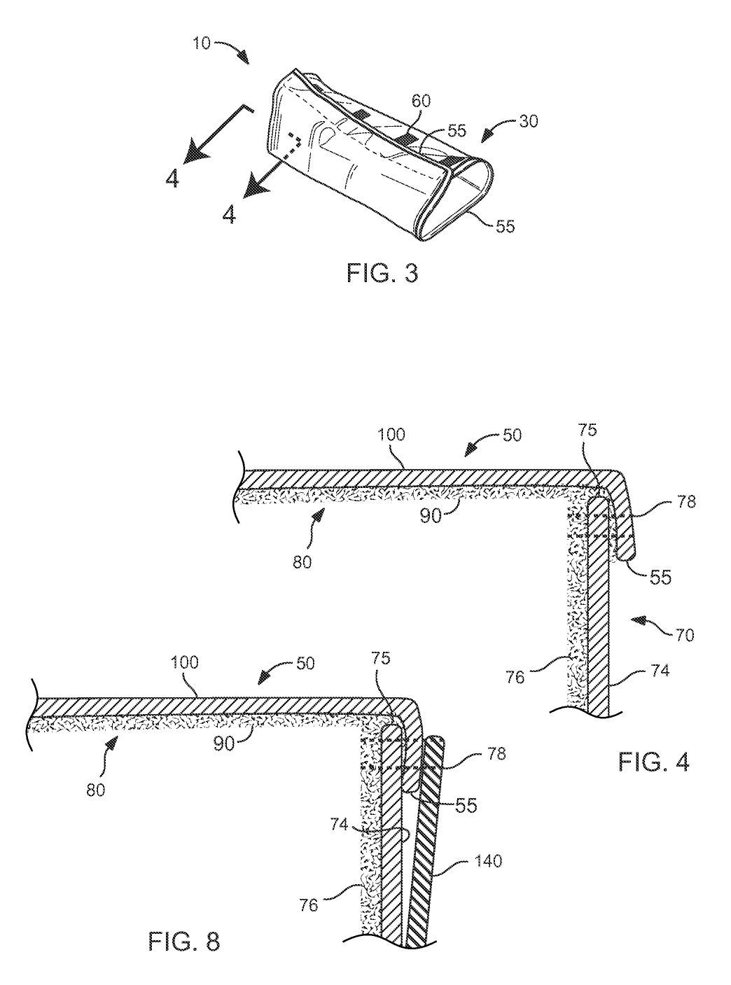

With respect to the drawings, FIGS. 1, 2, and 3 illustrate a combination 10 bed 20 and restraint 30 for a pet 40. In FIG. 2, the combination 10 includes a flexible sheet 50 having a top surface 56, a bottom surface 54, and at least one peripheral edge 55. The flexible sheet 50 includes a two-part fastening means 60 (FIG. 2) on the bottom and top surfaces 54,56. The top surface 56 of the flexible sheet 50 functions as the bed 20. In FIGS. 1 and 2, the combination further includes an end sheet 70 having an inside surface 76, and outside surface 74, and at least one peripheral edge 75. The peripheral edge 75 of the end sheet 70 is fixed to at least a portion of the peripheral edge 55 of the flexible sheet 50, such as by a sewn stitch 78, or the like (FIG. 4). Each sheet 50,70 may be hemmed along its edge 55,75, respectively.

As illustrated in FIG. 2, a distal end 58 of the flexible sheet 50 terminates at the end sheet 70 and a proximal end 52 of the flexible sheet 50 may be either laid substantially flat, thereby forming the bed 20, or as illustrated in FIGS. 1 and 2, wrapped around the pet 40 and fastened to itself 52 with the fastening means 60, thereby forming the restraint 30. Preferably, the pet 40 is contained in the restraint 30 in such a way that the pet's head 42 is the only part of the pet 40 exposed. Keeping the pet's head 42 exposed facilitates any desired actions regarding the pet's head 42, such as the administering of medicine (not shown) to the pet 40.

In a preferred embodiment, the fastening means 60 is a two-part hook-and-loop type fastener 61 (FIG. 2). In an alternate embodiment, the fastening means 60 is at least one mechanical snap 62 (FIG. 2). Clearly, alternate fastening means 60 may be used as is or becomes known in the art, provided such fastening means 60 include no sharp surfaces.

In one embodiment, the top surface 56 of the flexible sheet 50 further includes a soft, cushioning material 80 (FIG. 2). Providing the soft cushioning material 80 makes the invention suitable as a bed 20. In the embodiment shown in FIGS. 2 and 4, the flexible sheet 50 is comprised of a soft flexible inner layer 90 and a durable, flexible outer layer 100, each layer 90,100 mutually fixed together preferably by stitching (not shown), or adhesive, ultrasonic welding, or the like. The soft flexible inner layer 90 provides a soft surface for a pet 40 to rest on and the durable flexible outer layer 100 provides protection for a person 45 restraining the pet 40 (FIG. 1) and the combination 10 in general.

In a preferred embodiment, the inner layer 90 is taken from the set of materials comprising: fleece, wool, leather, and sheepskin. In another preferred embodiment, the outer layer 100 is taken from the set of materials comprising: fleece, leather, cotton, nylon, polyester, and denim. The invention has a novel design of being economical as it is made of basic materials and simple construction, yet is highly effective because the end sheet 70 prevents the pet 40 from escaping or slipping out of the restraint 30. Furthermore, the invention can be made of materials that are durable and washable.

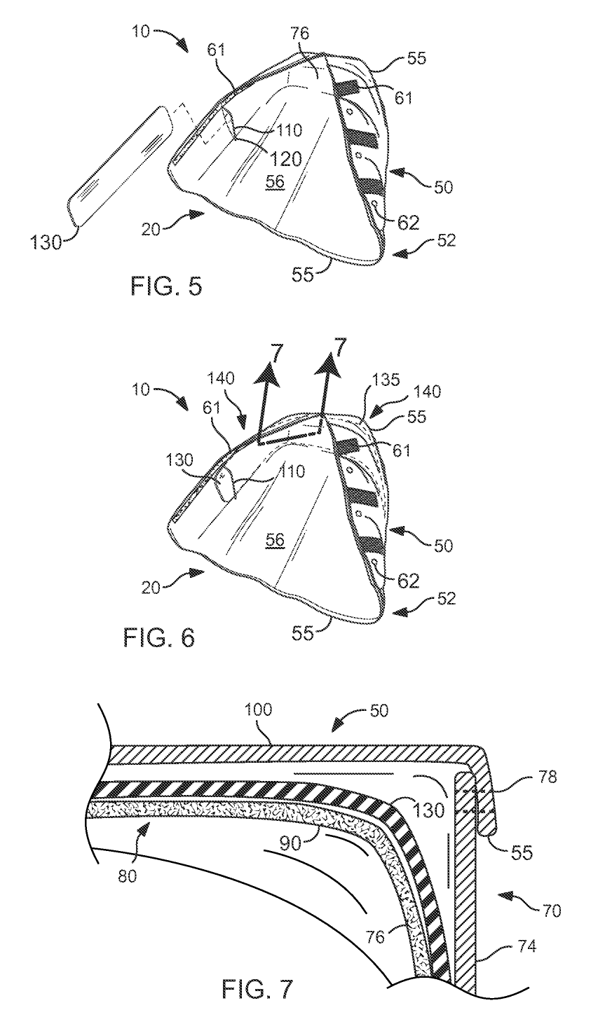

In another embodiment illustrated in FIGS. 5 and 6, the inner layer 90 further includes at least one aperture 110 sealable with a fastening means 120, and further including a resilient stiffener 130 insertable into the aperture 110 between the inner and outer layers 90, 100 (FIG. 7) to form a resilient bed wall 135 around a back periphery 140 of the combination 10 when used as the bed 20. Preferably two apertures 110 are provided on each side of the combination 10 so that the user may insert the stiffener 130 into one aperture while reaching inside the other aperture 110 to pull the stiffener 130 through to the other aperture 110. The fastening means 120 on each aperture 110 may then be sealed to contain the stiffener 130 within the combination 10. The resilient bed wall 135 provides a enclosure which is attractive to pets 40, especially cats, when they are selecting a place to rest. In a preferred embodiment, the resilient stiffener 130 is an elongated plastic sheet material. Other materials can be used for the resilient stiffener 130, such as a cardboard material.

In a preferred embodiment, the fastening means 120 is a zipper (FIG. 2), or a two-part hook-and-loop type fastener (not shown). Alternately, the fastening means 120 is at least one mechanical snap (not shown). In any embodiment, the resilient stiffener 130 is easily removable from the aperture 110. The ability to remove the resilient stiffener 130 facilitates the washing of the invention, especially washing the invention in a washing machine (not shown).

In another embodiment illustrated in FIG. 8, the combination 10 includes an end stiffener 140. The end stiffener 140 provides structural support to the end sheet 70 to facilitate the restraining of a pet 40. In a preferred embodiment, the end stiffener 140 is fixed to the peripheral edge 75 of the end sheet 70, such as by a sewn stitch 78, or the like (FIG. 8). The end stiffener 140 is preferably made of a semi-rigid plastic material, but can be made of any suitable rigid or semi-rigid material.

The invention is specifically designed to be attractive as a bed 20 for the pet 40. The invention opens up to a size suitable for a pet bed 20 and is made of a material that is attractively comfortable to the pet 40 but is still effective as a restraint 30. When not in use as a restraint 30, the combination 10 serves as the bed 20 for the pet 40 which makes the invention a familiar object to the pet 40. The familiarity of the pet 40 with the invention reduces the pet's resistance to being restrained and the pet's stress, thereby facilitating restraint of the pet 40.

While a particular form of the invention has been illustrated and described, it will be apparent that various modifications can be made without departing from the spirit and scope of the invention. For example, the invention could be made of scented material that is attractive to a pet. Accordingly, it is not intended that the invention be limited, except as by the appended claims.

What is claimed is:

1. A combination bed and restraint for a pet, comprising:
a flexible sheet having a top surface, a bottom surface, and at least one peripheral edge, the flexible sheet including a two-part fastening means on the bottom and top surfaces;
an end sheet having an inside surface, and outside surface, and at least one peripheral edge, the peripheral edge of the end sheet fixed to at least a portion of the peripheral edge of the flexible sheet;
whereby a distal end of the flexible sheet terminates at the end sheet and a proximal end of the flexible sheet may be either laid substantially flat, thereby forming the bed, or wrapped around the pet and fastened to itself with the fastening means, thereby forming the restraint.

2. The combination of claim 1 wherein the top surface of the flexible sheet further includes a soft, cushioning material.

3. The combination of claim 1 wherein the fastening means is a two-part hook-and-loop type fastener.

4. The combination of claim 1 wherein the fastening means is at least one mechanical snap.

5. The combination of claim 1 wherein the flexible sheet is comprised of a soft flexible inner layer and a durable, flexible outer layer, each layer mutually fixed together.

6. The combination of claim 5 wherein the inner layer is taken from the set of materials comprising: fleece, wool, leather, and sheepskin.

7. The combination of claim 5 wherein the outer layer is taken from the set of materials comprising: fleece, leather, cotton, nylon, polyester, and denim.

8. The combination of claim 5 wherein the inner layer further includes an aperture sealable with a fastening means, and further including a resilient stiffener insertable into the aperture between the inner and outer layers to form a resilient bed wall around a back periphery of the combination when used as the bed.

9. The combination of claim 8 wherein the resilient stiffener is an elongated plastic sheet material.
